(19) United States
(12) Patent Application Publication
(10) Pub. No.: US 2008/0178569 A1
(43) Pub. Date: Jul. 31, 2008

(54) MULTIFUNCTION BRUSH CUTTER HEAD

(76) Inventors: Donald Hamel, Val d'Or (CA); Daniel Rose, Val d'Or (CA)

Correspondence Address: Donald Hamel, 851, 5e Avenue, Bureau 221, C.P. 729, Val d'Or, QC, J9P 4P6, omitted

(21) Appl. No.: 11/626,902

(22) Filed: Jan. 25, 2007

(51) Int. Cl. A01D 34/00

(52) U.S. Cl. 56/15.2

(57) ABSTRACT

The multifunction brush cutter head attachment is versatile and designed for forestry operations, ground preparation for tree plantation, side road maintenance and other areas where precise cleaning of brushes and small trees is required. The invention consists of rotary shafts cutters as a cutting means to chop the brushes and small trees into wood chips or log sections. The steel welded frame of the invention includes two large opening ports on each side to avoid machine jams. The invention can reach hidden parts behind objects using a rotational system mounted on the top of the frame. Lengthways knives are secured with wedge blocks on the rotary shafts cutters and are easily removable for sharpening or maintenance. As the rotary shafts cutters have a low moment of inertia, the invention requires little power and is particularly suitable for small size excavator.

### CROSS-REFERENCE TO RELATED APPLICATION

Not-applicable

### STATEMENT REGARDING FEDERALLY SPONSORED R&D

Not-applicable

### REFERENCE TO SEQUENCE LISTING . . . APPENDIX

Not-applicable

### BACKGROUND OF THE INVENTION

1. Field of the Invention

The invention relates to a brush cleaning equipment that can be installed on the working boom of a small excavator. The described equipment can be used for trimming areas of undergrowth, shrubs and small trees.

2. Description of the Prior Art

Forestry operations, ground preparation for tree plantation and side road maintenance are all different areas where brush cleaning is required regularly. These operations can be done with manual brush cutting equipments but this way, the productivity is usually very low and operator's safety is a matter of concern. The introduction of mechanical brush cutting equipments improved productivity and safety in a significant way.

From the prior art, it can be found that there are two different groups of mechanical brush cutting equipment. One group refers to machines totally dedicated to brush cutting and not designed for other uses. The second group refers to mechanical working head equipments attached to a mechanical boom. This invention is related to the second group, the mechanical working head attachment equipment. The following patents are also associated to working head attachment for brush cutting operation.

U.S. Pat. No. 5,042,727 describes a brush cutting head attachment, using a plurality of cutting blades mounted on a vertical shaft. It operates in a limited vertical movement and is not designed for horizontally work as required for cleaning brushwood under larger trees.

U.S. Pat. No. 5,408,814 describes a brush cutter head attachment using a circular cutting blade to cut brushes. The attachment can cut trees into different lengths as well as chopping brushes into small chips.

U.S. Pat. No. 6,311,746 consists in an arrangement of four circular saws in a row. The brush cutting attachment can operate under any angle from horizontal to vertical. The group of circular saws is mounted on a same rail and can slide inside or outside to reach a larger field. The major inconvenient of this invention is related to the difficulty of chopping wood into small wood chips. Consequently, this brings extra cost to eliminate the wood residues left on the site.

U.S. Pat. No. 6,764,035 describes a brush cutter head attachment using several discs mounted on a horizontal main shaft to cut the brushes. Each disc has a plurality of cutting teeth that cut and chop the bushes to small chips. The movement of the equipment is mainly vertical but it can also work under large trees. As several discs are mounted on the main shaft, due to the high moment of inertia, it requires high torque and high power as used on large excavators which that are more expensive to acquire and to operate.

### SUMMARY OF THE INVENTION

The present invention offers a different kind of brush cutting equipment for cutting and chopping brushes, undergrowth, shrubs and small trees.

Therefore, an object of the present invention is to provide an attachment that can be used in several forestry operations rather than one or two with other attachments. The forestry operations are described as followed:
a) small trees felling: by cutting the tree stump and leaving the tree on site;
b) trees or brushes chopping: to reduce the tree or the brushes into small wood chips left on the site for soil enrichment;
c) small trees harvesting: by cutting wood in different lengths.
d) small trees trimming: by cutting the trees boughs for growing purpose.

More particularly, the present invention relates to a multifunction brush cutter head to be installed at the tip end of a small excavator working boom and comprising:
a) a rigid steel welded frame with two large open ports on each side;
b) perpendicular to the open ports, a plurality of rotating grooved shafts cutter where lengthways knives are inserted and secured;
c) a motorization to put the shafts in rotation;
d) a mechanical rotation system to operate the said brush cutter head in several positions.

Therewith, an aspect of the present invention is a steel welded frame with a front plate and a back plate. Another bent plate makes the top shielding and half length sides over the rotating shafts. Behind the back plate, there is an end plate welded with sides to the back plate that form a hollow section to hold the pulleys and belts drive of the motorization. Therefore, large open ports are at the bottom of the attachment. This design is highly efficient to avoid machine jams. The design of the steel welded frame offers the possibility to cut brushes in a forward mode, a backward mode and sideways mode because there is no definite entrance and exit ways. In fact, in the forward mode the working boom and the multifunction brush cutter head is pushed ahead through the brushes up to the full extension length of the boom. Then, the said boom is brought back in the backward mode and brushes will still be cut. This increases by double the productivity of the operation. The boom operating sequence of forward and backward or sideways action can be associated to a double pass action. This way of working is more efficient compared to many other brush cutter equipments that can only work under a single pass forward action.

Another particularity of the present invention is the small diameter of the rotating shafts cutters. In comparison with cutting wheel and sawing blade, rotating shafts cutters have a lower moment of inertia requiring less power to put the said shafts in motion as well as to stop them. Several brush cutting equipment have big shafts cutter 6 to 8 inches (0.1524 m to 0.2032 m) diameter. With such diameters, the moment of inertia is about 1408 lb.in² to 4453 lb.in² (0.412 kg.m² to 1.303 kg.m²) using the standard formula I=(Mr²)/2 for a solid cylinder rotating on its longitudinal axe where I is the moment of inertia and M is the mass of the shaft (we assume a length of 39 inches and a shaft made of steel as example to calculate the mass) and r is the radius of the shaft. With the present invention, the rotary shafts cutter diameter is lower than 3 inches (0.0762 m) and the moment of inertia is therefore 89 lb.in² (0.026 kg.m²). Also with three rotary shafts cutters, the total moment of inertia is about 267 lb.in² (0.078 kg.m²). The lower moment of inertia allows the installation of the present invention on small excavator with an operating weight less than 10 tons rather than other brush cutting equipments that are installed on bigger excavators with an operating weight from 10 to 20 tons.

Rotating shafts cutters are also best suited for chipping the brushes because the cutting action is similar to wood planing. Rotary shafts cutters are also different from cutter wheels and sawing blades as they stand in place by the ends and not by the center.

Another object of the present invention is to use a motorization to put the rotating shafts in motion. The motor is preferably hydraulic but it can also be electric. When a hydraulic motor is used, the pressure oil is supplied by the hydraulic system of the excavator. The power from the motor can be transferred to the rotating shafts cutters by the use of pulleys with belts or sprockets with chain or by the use of gears train. Belt drives are preferred as they offer a mechanical shock dampener for the motor. Another embodiment of the motorization unit is the use of direct drive motors. In such case, each rotating shaft cutters have their own motor.

Another particularity of the invention is the mechanical rotation system of the head. The rotational system is mounted on the top of the frame and attached to the boom of the excavator. This embodiment enhances the operating potential of the multifunction brush cutter head. In fact, the mechanical rotation system offers the possibility to surround an object with little or any movement of the excavator supporting the brush cutting head. The rotation system allows a rotating action up to 300 degrees of the applicant brush cutter and therefore raises the working capacity in different sites.

Finally, another particularity of the present invention is an attachment for quick releasable coupling of the multifunction brush cutting head with the working boom of the excavator.

### BRIEF DESCRIPTION OF THE DRAWINGS

FIG. 1 is a general view of a small excavator with the brush cutting head in a typical working environment.

FIG. 2 shows the operating option of the present invention to clean brushes around larger trees with the rotational system without moving the excavator on the soil.

FIGS. 3, 4, 5 & 6 are respective views of the brush cutting head uses for tree felling, trimming, rough cleaning, and fine cleaning with wood chipping operation.

FIG. 7 is a view of the single head model of the invention.

FIG. 8 is a view of the double head model of the invention.

FIG. 9 illustrates a side view of the single head model of the invention.

FIGS. 10, 11 & 12 illustrate cross-section views taken along line 10-10 in FIG. 9 showing different embodiments of the rotary shafts cutter.

FIG. 13 illustrates a cross-section view taken along line 13-13 in FIG. 9 showing the rotary shafts cutter and the knives.

FIG. 14 illustrates a cross-section view taken along line 14-14 in FIG. 9 showing the mechanical rotation system.

FIG. 15 illustrates an explode view of the head with the motor and the driving system.

### DETAILED DESCRIPTION OF THE INVENTION

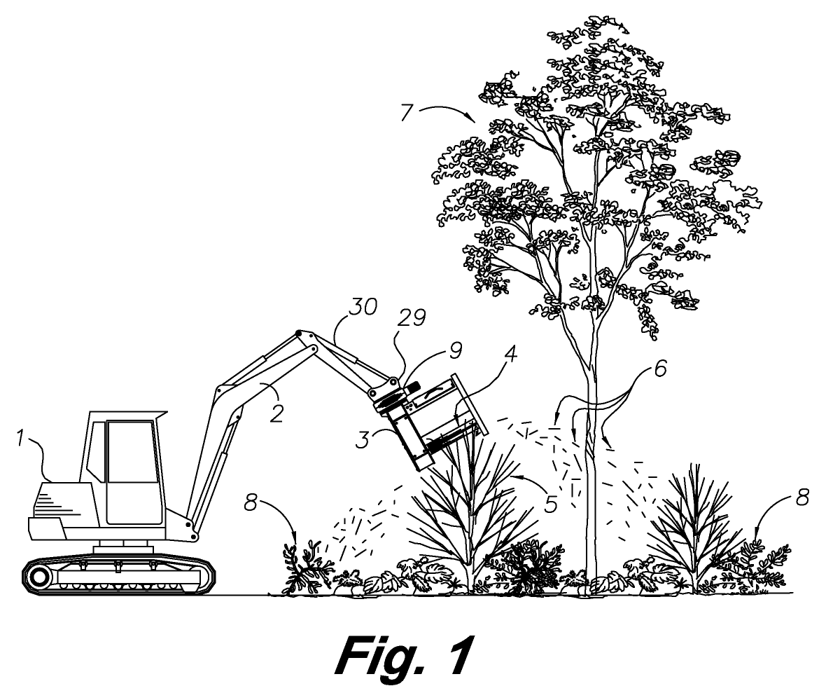

FIG. 1 illustrates a typical working area for the present invention. A small excavator 1 actuates a working boom 2 to which the multifunction brush cutter head 3 is attached. The said brush cutter has several rotary cutter shafts 4 that will chop the brushes 5 to smaller twigs 6. The multifunction brush cutter head 3 also has a mechanical rotating system 9. The mechanical rotation system 9 is bolted on the top of the brush cutter head 3. The mechanical rotation system 9 has a welded attachment 29 with bore holes to lock it to the tip end of the working boom 2 and to the hydraulic cylinder 30 by the use of a locking device like shaft pins. As illustrated in FIG. 1 a typical working area may include larger trees 7, brushes 5 and undergrowth 8. Thereby, cleaning operation will require cutting undesirable vegetation close to the larger tree 7.

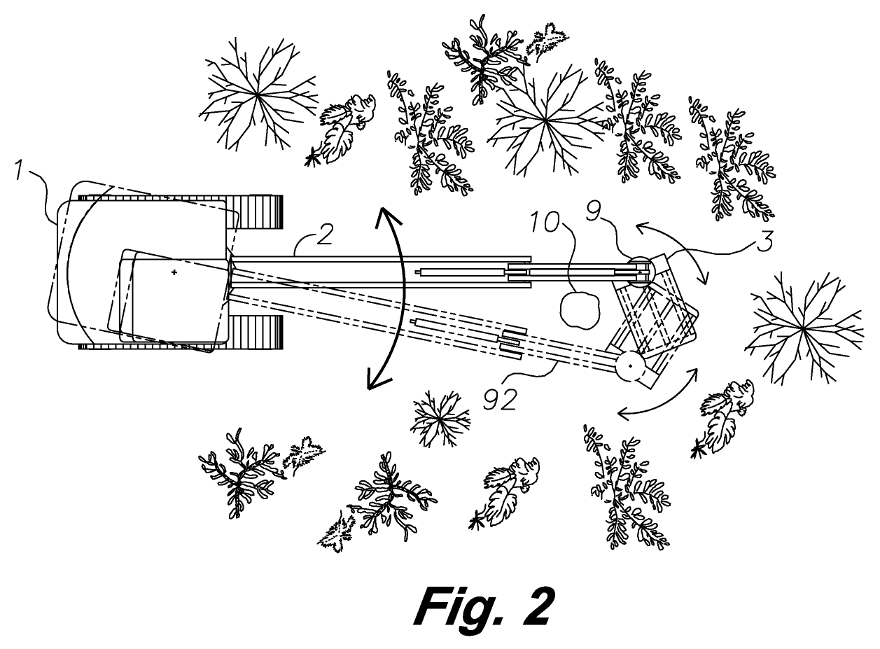

FIG. 2 illustrates a top view of preferred working embodiments associated with the present invention. The small excavator 1 is in front of a tree 10 and brushes around must be cut. With the present invention it is possible to surround the tree 10 and to cut brushes aside and behind it. Furthermore, the brush cutting operation aside and behind the tree 10 does not require moving the small excavator 1 avoiding roots and soil compaction and increasing operation productivity. As shown in FIG. 2, the mechanical rotation system 9 allows the rotating action of the multifunction brush cutter head 3. Also shown in FIG. 2, the present brush cutter head 3 may rotate up to 150 degrees on both left and right hand sides around a tree, a post or any permanent object. Also in FIG. 2, the phantom lines 92 show the position that the multifunction brush cutter head 3 can take without moving the excavator 1 by moving only the working boom 2 and rotate the mechanical rotation system 9 to reach brushes behind the tree 10.

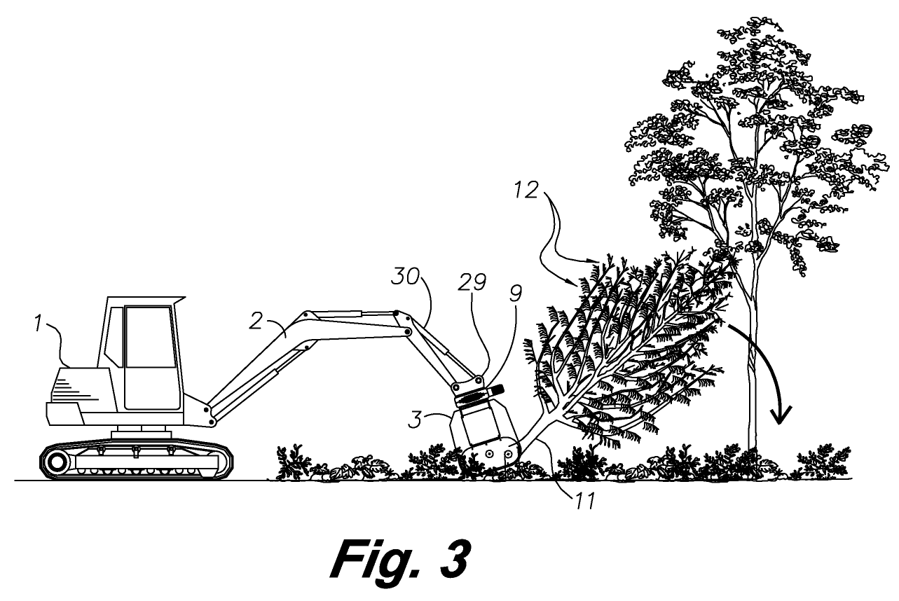

FIGS. 3, 4, 5 & 6 illustrate other preferred working embodiments of the present invention.

FIG. 3 illustrates the operation of small tree felling where the tree stump 11 is cut. The tree boughs 12 can be chopped before or after the felling operation. Also valuable sections of the small tree might be used in further wood transformation.

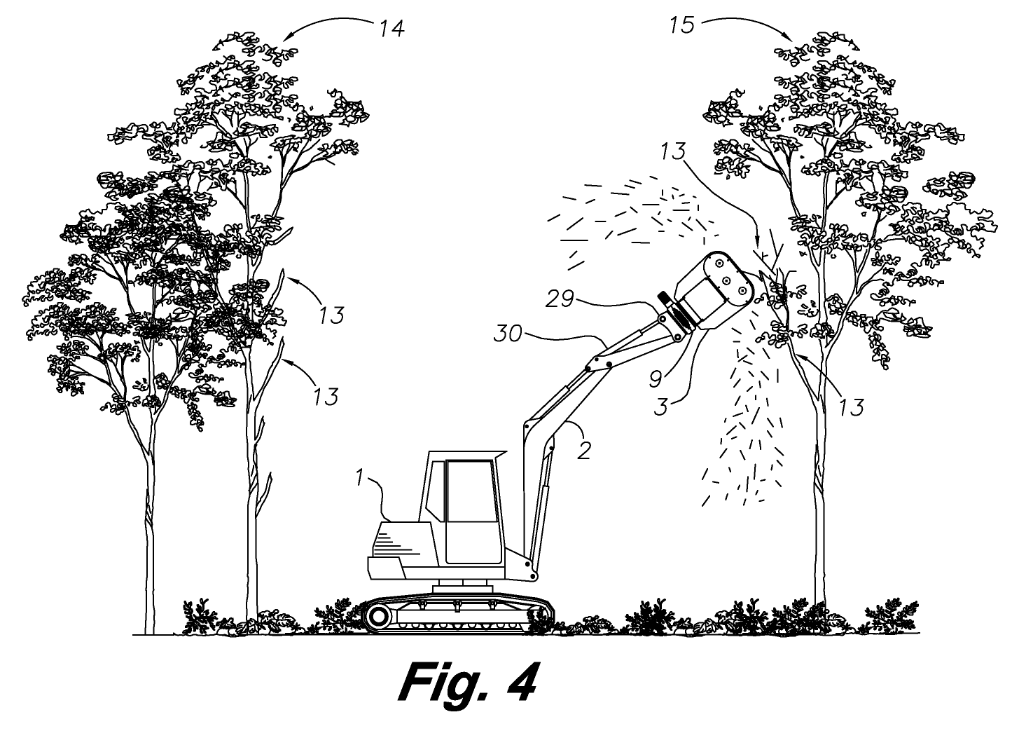

FIG. 4 illustrates the tree boughs trimming operation in a typical tree plantation. In this kind of operation the excavator 1 and the multifunction brush cutter head 3 should preferably be between two rows of trees 14 and 15 (only the first tree of the row is showed to simplify the drawing). The said brush cutter head 3 will be pivoted to face the tree row. Tree trimming will be performed by moving the working boom 2 and the brush cutter head 3 from top to bottom and by the reversed sequence bottom to top to trim the boughs 13. Using the mechanical rotation system 9 the multifunction brush head 3 can trim the left and the right hand side trees without moving the excavator 1 which increases the productivity.

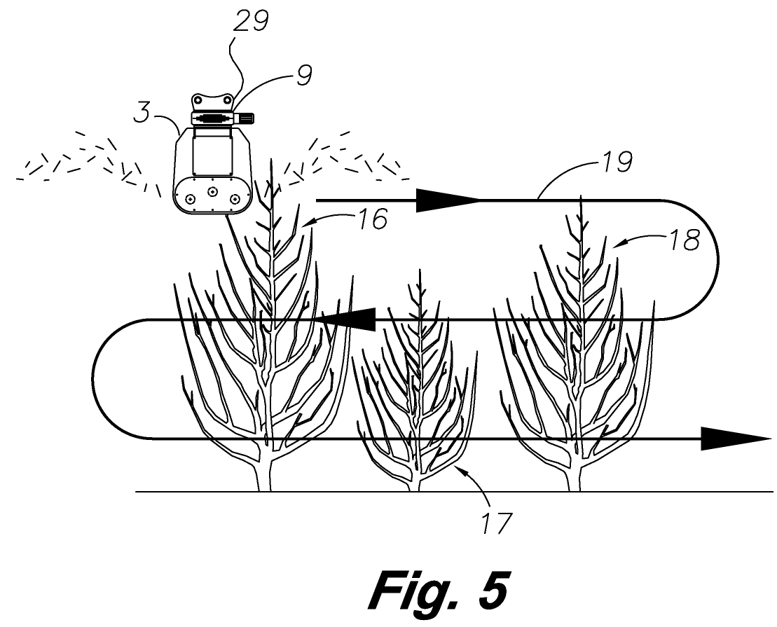

FIG. 5 illustrates a rough cleaning operation (for example) through brushes 16, 17 and 18. The brush cutter head 3 is showed without the excavator. In this kind of operation the multifunction brush cutter head 3 starts from the far left hand side for example and at the top of the brushes 16. By moving the working boom 2 (not shown) and the brush cutter head 3 to the far right hand side in order to follow the pattern 19, a layer of brushes 16, 17 and 18 will be cut. By lowering the working boom 2 (not shown) to the middle height of the brushes 18 and by moving the brush cutter head 3 to the far left hand side another layer of brushes 18, 17 and 16 will be cut. By repeating the above sequence once again for the lowest layer of brushes the rough cleaning operation will be completed. Brushes 16, 17 and 18 are chopped into small wood chips and long wood strips.

FIG. 6 illustrates a fine cleaning and chopping operation (for example) through brushes 16, 17 and 18. The operation sequence is similar to the one described in FIG. 5 with the following difference: the operator will start from the far left hand side for example and at the top of the brushes 16. By moving the working boom 2 (not shown) and the brush cutter head 3 to the far right hand side to follow the pattern 20, a layer of brushes 16,17 and 18 will be cut. The said brush cutter head 3 will then be lowered to an approximate distance equivalent to half the height of the brush cutter head 3. By moving the brush cutter head 3 to the far left hand side and therefore, another layer of brushes 18, 17 and 16 will be cut. This operation will generate small wood chips which are sometimes requested for cleaning operation close to power lines and side road maintenance.

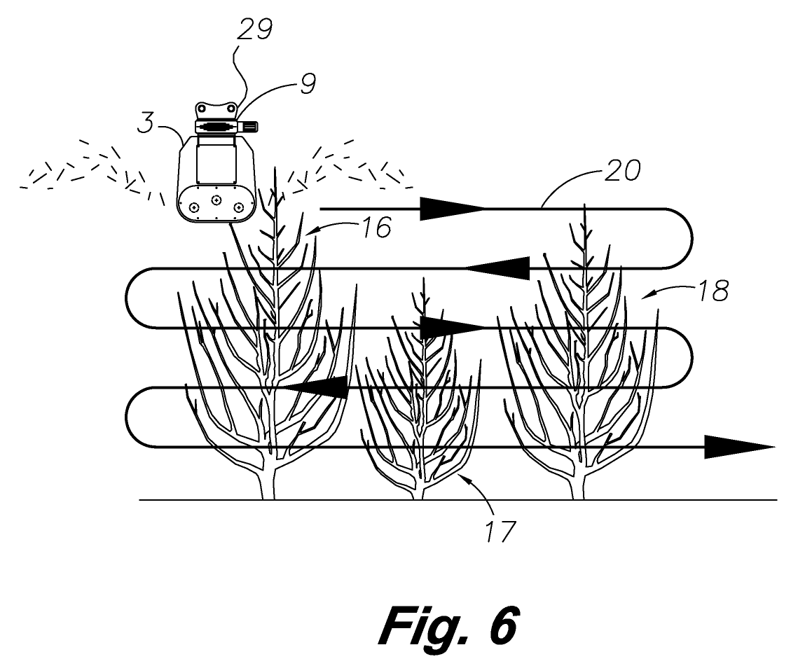

The preferred embodiment of the present invention is illustrated in FIG. 7 where the multifunction brush cutter head 3 has a rectangular steel welded frame. The steel welded frame has a front plate 21, a back plate 22 and an end plate 23. The front plate 21 is a pseudo rectangular flat plate forms by narrower up section with a surrounding flat edge strip 24. The back plate 22 and the end plate 23 have the same shape as the front plate 21 and are welded with a side plate 25 near and around the edges of said plates to form a hollow section holding the pulleys and belts drive of the motor. The steel welded frame has also a top shielding 26. The top shielding 26 is a bent plate that also forms the half sides of the frame over the rotating shafts cutter 4. Over the shielding top 26, there is another bent plate 27 with a hinge cover 28. The top shielding 26 and bent plate 27 are welded between the front plate 21 and the back plate 22. The multifunction brush cutter head 3 also has rotary shafts cutters 4 between the front plate 21 and back plate 22. The main action of the rotary shafts cutter is to chop the brushes and undergrowth into small wood chips and twigs. As the multifunction brush cutter head might have only one rotary shaft cutter, it may also have several and the preferred embodiment is an arrangement of three as detailed in FIG. 7.

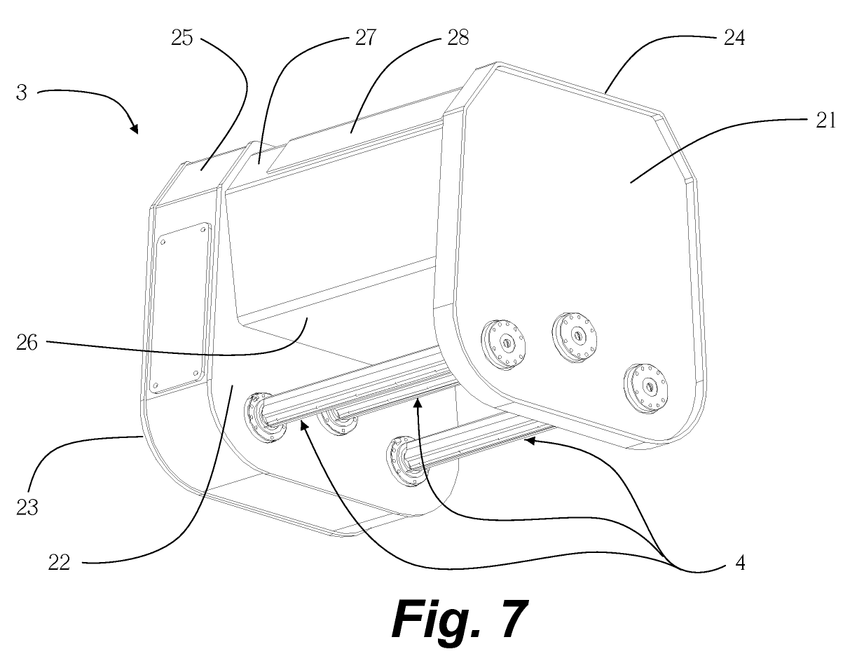

A second embodiment of the present invention is the double head brush cutter 31, only illustrated in FIG. 8. This embodiment contributes to double the productivity with the same motorization on larger ground areas. The double head brush cutter 31 is a single head brush cutter as described in FIG. 7 with more rotary shafts cutter 4b located symmetrically behind the endplate 23. The said double head has a longer rectangular steel welded frame. The steel welded frame has a two front plate 21 and 21b, a back plate 22 and an end plate 23. The front plates 21 and 21b are a pseudo rectangular flat plate forms by narrower up section with two surrounding flat edge strip 24 and 24b. The back plate 22 and the end plate 23 have the same shape as the front plate 21 and are welded with a side plate 25 near and around the edges of said plates to form a hollow section holding the pulleys and belt drives of the motor. The steel welded frame has also two top shielding 26 and 26b. The top shielding 26 is over the rotary shafts cutter 4 and the top shielding 26b is over the rotary shafts cutter 4b. The top shielding 26 and 26b are bent plates that also form the half sides of the frame over the rotating shafts cutter 4 and 4b. Over the shielding top 26 and 26b, there are two bent plates 27 and 27b with two hinge covers 28 and 28b. The top shielding 26 and bent plate 27 are welded between the front plate 21 and the back plate 22. The top shielding 26b and bent plate 27b are welded between the front plate 21b and end plate 23.

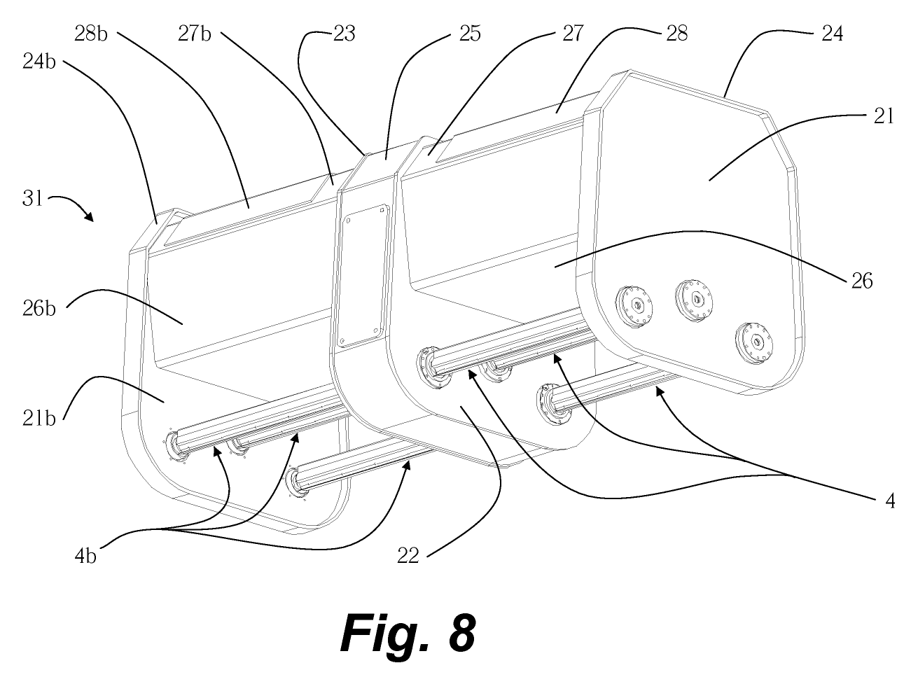

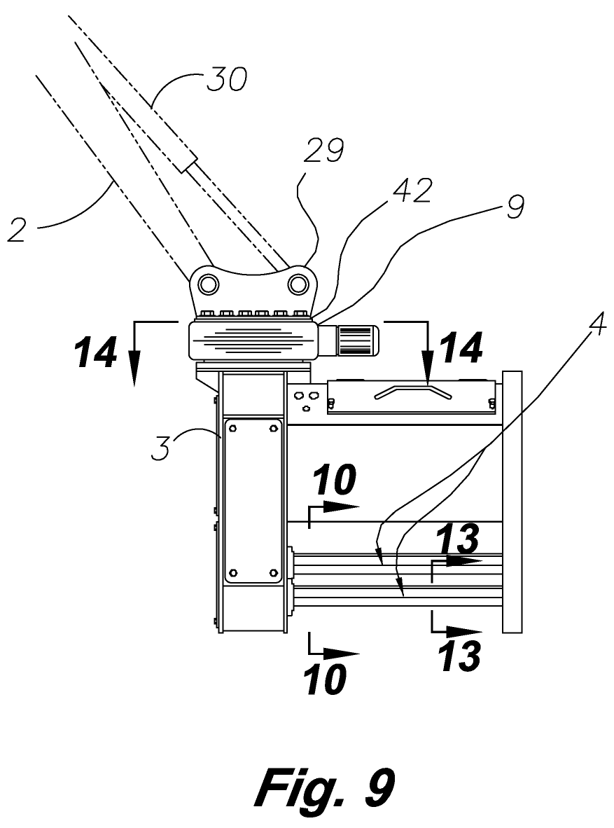

FIG. 9 illustrates a side view of multifunction brush cutter head 3 to show the line 10-10, 13-13 and 14-14 of cross-sectional views described in FIGS. 10 to 14.

FIG. 10 illustrates a cross-section view taken along line 10-10 in FIG. 9. It was previously said, that the multifunction brush cutter head 3 can have one rotary shaft cutter 4 or several but the preferred embodiment is an arrangement of three as shown.

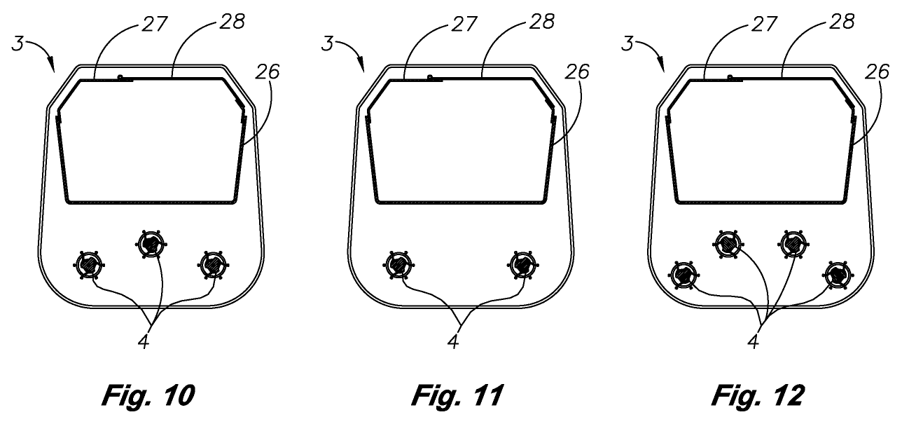

FIG. 11 illustrates a cross-section view taken along line 10-10 in FIG. 9. to show an alternate embodiment with two rotary shafts cutters 4.

FIG. 12 illustrates a cross-section view taken along line 10-10 in FIG. 9. to show an alternate embodiment with four rotary shaft cutter 4.

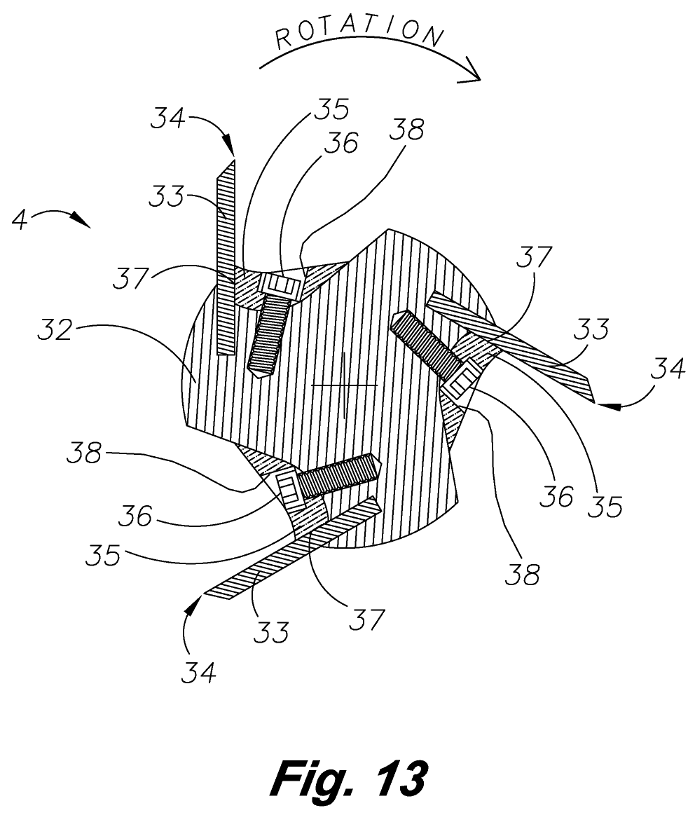

FIG. 13 illustrates a cross-section view taken along line 13-13 in FIG. 9. to show the details of how the knives are secured to the rotary shaft cutters 4. The central portion 32 is a round shaft machined to receive the knives 33 with sharpens edges 34, the wedges 35 and the compression bolts 36. The knives 33 are secured to the central portion 32 with a wedge 35 designed to take on the exact shape in the central portion 32 and when the compression bolts 36 are tightened, the wedges taper sides 37 push against the knives 33 and hold them firmly in place. The compression bolts 36 are hollow hexagonal head bolts (Allen bolts) seating in a bore hole 38 drilled and bored through the wedges 35.

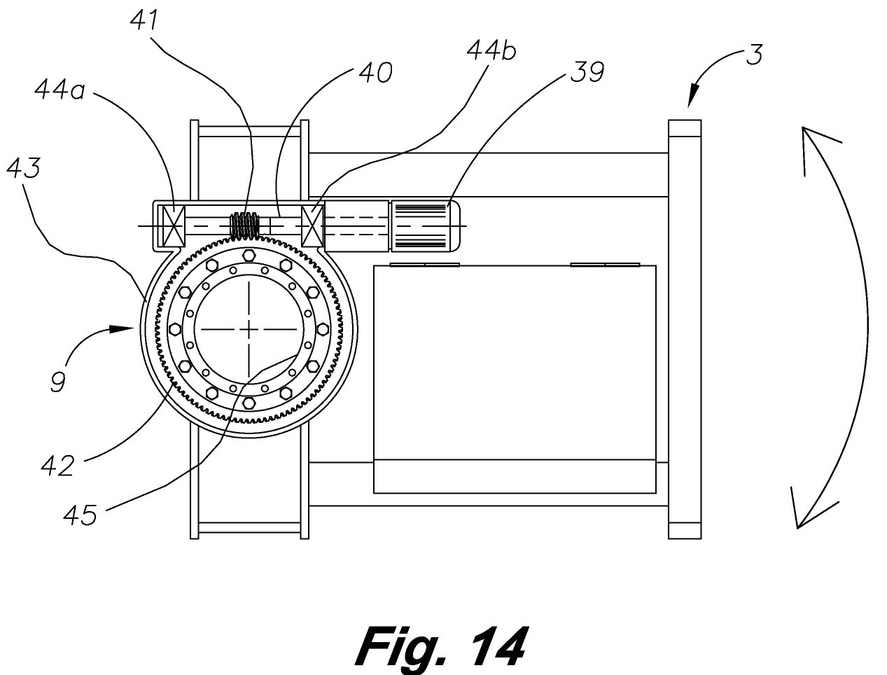

FIG. 14 illustrates a cross-section view taken along line 14-14 in FIG. 9 to show the mechanical rotation system 9. This system allows lateral rotation movement of the multifunction brush cutter head 3 up to 300 degrees. The casing 43 of the mechanical rotation system is bolted on the top of the frame of brush cutter head 3. A hydraulic motor 39 is used to rotate the drive shaft 40 held in place in the casing 43 with two bearings 44a and 44b. On the drive shaft 40, there is a worm screw 41 that put the worm gear 42 in rotation around the bearing unit 45. The worm gear 42 is bolted under the welded attachment 29 (not shown) itself locked on the tip end of the working boom 2 (not shown) and to the hydraulic cylinder 30 (not shown). The bolts of the worm gear 42, the welded attachment 29, the working boom 2 and the hydraulic cylinder 30 have been previously showed in a side view in FIG. 9.

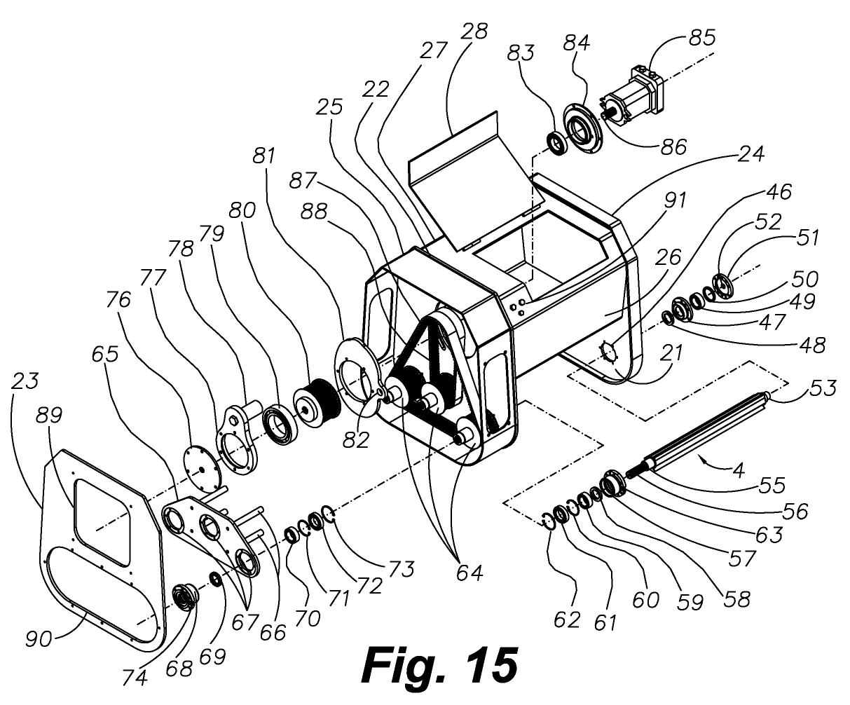

FIG. 15 illustrates a detailed exploded view of the brush cutter head 3 (only one rotary shaft cutters is shown and every bolts and has been removed to simplify the drawing). The front plate 21 has bore holes at the bottom to support the rotary shafts cutter 4. In the preferred embodiment there are three bore holes 46 (one shown, two hidden) arranged like a triangular pattern. In each of the bore holes a front hub 47 is used to support the front end 53 of the rotary cutter shafts 4. Each front hub 47 has a spherical roller bearing 49, a shaft seal 48, a snap-ring 50 (also called “circlip”, this fastener consists in a sprung ring with open ends that can be snapped into a machined groove to allows rotation but to prevent lateral movement) and an end cover 51. The front hub 47 is bolted to the front plate 21. Lubrication fluid is added to the bearing by a greasing point 52 screwed on the end cover 51. The back plate 22 also has bore holes at the bottom arranged in the same triangular pattern as in the front plate 21. In each of the bore holes a back hub 57 is used to support the back end 55 of the rotary shaft cutters 4. Each back hub 57 has a spherical roller bearing 59, a shaft seal 58, a first snap-ring 60, a ball bearing 61 and a second snap-ring 62. The back hub 57 is bolted to the back plate 22. Lubrication fluid is added to the bearings by a greasing point 63 screwed on the back hub 57. The spherical roller bearing 59 allows rotation between the back end 55 of the rotary shaft cutters 4 and the fixed end hub 57. The ball bearing 61 allows rotation between the toothed pulley 64 and the fixed end hub 57.

The end section 56 of the rotary shaft cutters 4 has outer machined spline grooves thus inserted in the inner machined spline grooves of toothed pulley 64 to have a good mechanical link when the toothed pulley 64 is in rotation.

The three toothed pulleys 64 must be supported on the other side by end hubs 68 that are similar to the back hubs 57. Each back hub 68 (one shown, two hidden) is bolted in the bore hole 67 of the support plate 65 attached to the back plate 22 with four bolts that goes through four hollow rods 66. Each back hub 68 has a spherical roller bearing 70, a shaft seal 69, a first snap-ring 71, a ball bearing 72 and a second snap-ring 73. Lubri-cation fluid is added to the bearings by a greasing point 74 screwed on the back hub 68.

The three toothed pulleys 64 get in rotation with two toothed belts 87 and 88. The toothed pulley 80 drives the central toothed pulleys 64 with first toothed belt 88. The toothed pulley 80 drives the two other lower toothed pulleys 64 with the second toothed belt 87. The driving toothed pulley 80 is supported by two bearings in a tightening device which includes: a flange plate 84, a roller bearing 83, a main plate 81, a roller bearing 79 a bearing holder 77 and an end cover 76. The end cover 76 is bolted to the bearing holder 77. The bearing holder 77 is bolted on the hollow rod 78 welded on the main plate 81. The flange plate 84 is bolted on the main plate 81. The main plate 81 of the tightening device is mounted by the hole 82 and bolted on a pivot pin (not shown) welded on the back plate 22. A bolt (not shown) located on the other side of the back plate 22 allows to block the tightening device when the belts tension is adequate.

The hydraulic motor 85 is bolted on the flange plate 84 and the motor's shaft 86 has outer machined spline grooves thus inserted in the inner machined spline grooves of driving toothed pulley 80. This kind of assemblage ensures a good power transmission from motor 85 to the rotary shafts cutters 4. Also the hydraulic motor 85 is protected and located inside the compartment formed by the top shielding 26, the bent plate 27, the hinge cover 28, the front plate 21 and the back plate 22. The hydraulic hoses (not shown) are connected from the motor 85 to the hydraulic ports 91 for quick coupling purpose. The end plate 23 is welded on the side plate 25. There are two openings 89 and 90 to make maintenance of components easier. Those openings have bolted covers (not shown) during normal operation of the brush cutter head.

### Front Page View

Use FIG. 1 for inclusion on the front page of the patent application and patent as the illustration of the invention.

1. A multifunction brush cutter head for cutting brushes, undergrowth and small trees comprising:
a steel welded frame with two large open ports, one on each side, that avoid machine jams, the said frame is made of three parallel plates, a front plate, a back plate and an end plate, the said front plate is joined to said back plate with a bent plate perpendicular to form a top shielding at the half height of said frame, the said back plate is joined to said end plate with a side plate perpendicular and bent around the edges of said back plate and said end plate to form a rigid hollow section;
a rotary shaft cutters uses as a cutting mean and mounted perpendicularly to said open ports at the bottom of said frame, under said shielding top and between said front plate and said back plate;
a plurality of removable knives that are secured on the said rotary shaft cutters;
a motorization mean to put the said rotary shaft cutters in rotation;
a mechanical rotation system that allows rotation of the said brush cutter head on an horizontal plane for 300 degrees.

2. A multifunction brush cutter head, as cited in claim 1, where the cutting is done by the rotational action of the knives that are secured on the rotary shaft cutter, said shaft is supported by bearings and having driven toothed pulley at one end, said driven toothed pulley is belted to the motor drive toothed pulley in such a way that when the motor under power, the rotary shaft cutters starts turning.

3. A multifunction brush cutter head as cited in claim 1, where a plurality of rotary shafts cutters can be used.

4. A multifunction brush cutter head as cited in claim 1, where the rotary shaft cutters motorization is selected from group consisting of belt driven, chain driven, gear driven and direct driven.

5. A rotary shaft cutters as cited in claims 1 or in claim 3, comprising:
three machined longitudinal grooves equally distributed around the said shaft to insert the knives;
three machined longitudinal concave section beside each said groove with a plurality of equally distributed treaded holes;
three longitudinal wedge blocks designed to take on the exact shape of the said concave section with one taper side facing the said grooves;
a plurality of compression bolts tightened in a plurality of bore holes drilled and bored through the said wedges to secure the said knives firmly on the said shaft with the said taper side pushing against the said knives.

6. A rotary shaft cutters as cited in claim 1 or in claim 3, has a low moment of inertia that does not exceed 0.026 Kg.m² (kilogram square meter).

7. A multifunction brush cutter head as cited in claims 1 that can be used for a plurality of forestry operations such as brush cleaning tree felling, tree trimming and tree harvesting.

8. A multifunction brush cutter head as cited in claims 1 that can be mounted on small size excavators that have an operating weight lower than 10 metric tons.

9. A multifunction double head brush cutter for cutting brushes, undergrowth and small trees comprising:
a steel welded frame with four large open ports, two on each side in order to avoid machine jams, the said frame is made of four parallel plates, a first front plate, a back plate, an end plate and a second front plate, the said first front plate is joined to said back plate with a perpendicular bent plate forming a first top shielding at the half height of said frame, the said back plate is joined to said end plate with a perpendicular side plate and bent around the edges of said back plate and said end plate forming a rigid hollow section, the said end plate is joined to said second front plate a with perpendicular second bent plate symmetrical to said bent plate and to form a second top shielding at the half height of said frame;
a set of two rotary shafts cutters used as cutting mean and mounted perpendicularly to the said open ports at the bottom of said frame, the first said shaft is under said first top shielding and between said first front plate and said back plate, the second said shaft is under said second top shielding and between said second front plate and said end plate;
a plurality of removable knives that are secured on the said rotary shafts cutters;
a motorization mean to put the said rotary shafts cutters in rotation;
a mechanical rotation system that allows a rotation of the said double head brush cutter on an horizontal plane for 300 degrees;

10. A multifunction double head brush cutter, as cited in claim 9, where the cutting is done by the rotational action of the knives that are secured on the rotary shafts cutters, said shafts are supported by bearings and having driven toothed pulley where the end of said shafts are inserted and blocked, said driven toothed pulley is belted to the motor drive toothed pulley in such a way that when the motor is under power, the rotary shafts cutters starts turning.

11. A multifunction double head brush cutter as cited in claim 9, where a plurality of rotary shafts cutters can be used.

12. A multifunction double head brush cutter as cited in claim 9, where the rotary shafts cutters motorization is selected from the group consisting of belt driven, chain driven, gear driven and direct driven.

13. A rotary shaft cutters as cited in claim 9 or in claim 11, comprising:
three machined longitudinal grooves equally distributed around the said shaft to insert the knives;
three machined longitudinal concave section beside each said groove with a plurality of equally distributed treaded holes;
three longitudinal wedge blocks designed to take on the exact shape of the said concave section with one taper side facing the said grooves;
a plurality of compression bolts tightened in a plurality of bore holes drilled and bored through the said wedges to secure the said knives firmly on the said shaft with the said taper side pushing against the said knives.

14. A rotary shaft cutters as cited in claim 9 or in claim 11, has a low moment of inertia that does not exceed 0.026 Kg.m² (Kilogram square meter).

15. A multifunction double head brush cutter as cited in claim 9 that can be used for a plurality of forestry operations such as brush cleaning, tree felling, tree trimming and tree harvesting.

16. A multifunction double head brush cutter as cited in claim 9 which can be mounted on small size excavators that have an operating weight lower than 10 metric tons.
